(19) United States
(12) Patent Application Publication
(10) Pub. No.: US 2003/0048459 A1
(43) Pub. Date: Mar. 13, 2003

(54) Measurement system and method

(76) Inventor: Richard Michael Gooch, Surrey (GB)

Correspondence Address: Crowel & Moring, Intellectual Property Group, PO Box 14300, Washington, DC, 20044-4300, US

(21) Appl. No.: 10/089,892

(22) PCT Filed: Apr. 6, 2001
(86) PCT No.: PCT/GB01/01590

(30) Foreign Application Priority Data
Apr. 6, 2000 (GB) 0008303.0

(51) Int. Cl. G01B 11/14

(52) U.S. Cl. 356/620

(57) ABSTRACT

This invention relates to a measurement system for use in computer aided manufacture or computer aided inspection comprising a base measurement system (4, 5a, 5b, 7a, 7b) and a sensor means (2), the sensor means being movable independently of the base measurement system and being arranged to determine the distance between the sensor means and a selected point, the base measurement system being arranged to determine the position of the sensor means relative to the base measurement system, the system comprising processor means (4) being arranged to receive information generated by the base measurement system and the sensor means and the processor means being further arranged to derive position information relating to the selected point relative to the base measurement system.

The present invention relates to a method for collecting measurement data, particularly but not exclusively dense three dimensional measurement data relating to an object which is hidden from the measuring system.

Manufacturing process control and inspection often require three dimensional measurements to be made with respect to the manufactured object or tooling used in the manufacture of an object.

Various devices are currently available for performing measurements of this type. These include jointed arm portable co-ordinate measuring machines, photogrammetry systems and laser trackers. However, each of these devices suffers from the problem of access to objects. That is to say, that the object to be measured may have points requiring measurement, which are hidden from the direct line of sight of an optical measurement system, or are out of range or occluded from a contact based measurement system.

Furthermore, if dense measurement data is required, the task of carrying out the required measurements with a single point device may be slow and labour intensive. Additionally, if dense measurement data is required, the types of probe used in each of these techniques may be physically, too large to allow useful measurement data to be obtained.

One solution to this problem is the Faro arm and Modelmaker combination, available from UFM Limited, 416418 London Road, Isleworth, Middlesex TW7 5AE, United Kingdom. The Faro arm is a portable co-ordinate measuring arm incorporating accurate angular encoders, which can output position information relating to the wrist of the measuring arm in six degrees of freedom. Modelmaker is a laser stripe scanner that can be attached to the Faro arm. The measurements output from Modelmaker are combined with the position information output from the Faro arm, from which a scanned surface may be represented in six degrees of freedom. The freedom of movement of the co-ordinate measuring arm combined with the non-contact, dense measurement capabilities of the laser stripe scanner allows measurement data to be generated which may be hidden or too dense to be easily measured using conventional measurement systems.

However, as has been stated above, the Faro arm relies upon accurate encoders to yield satisfactory position information. Additionally, it is unpowered, relying on a human operator to provide its actuation. Thus, a co-ordinate measuring arm such as the Faro arm is unsuited to applications where the arm is required not only to carry a laser striper, but also a manufacturing tool. Because the mass of the tool may cause a degree of compliance in the arm, the position output by the angular encoders may deviate from the actual position of the laser striper and tool mounted on the arm.

Therefore, there is a need for a method of collecting dense measurement data which overcomes one or more of the disadvantages of the prior art.

According to a first aspect of the present invention, there is provided a measurement system for use in computer aided manufacture or computer aided inspection comprising a base measurement system and a sensor means, the sensor means being movable independently of the base measurement system and being arranged to determine the distance between the sensor means and a selected point, the base measurement system being arranged to determine the position of the sensor means relative to the base measurement system, the system comprising processor means being arranged to receive information generated by the base measurement system and the sensor means and the processor means being further arranged to derive position information relating to the selected point relative to the base measurement system.

Advantageously, by arranging for the sensor of the present invention to be movable independent of the base measurement system, the present invention does not suffer from measurement inaccuracies resulting from the compliance, or lack of rigidity, of the base measurement system. Thus, manufacturing tools, such as a drills, welding devices or marking out devices (including punches, scribers or ink devices etc.), may be used in association with the sensor without causing consequential measurement inaccuracies.

Additionally, the accuracy with which the base measurement system of the present invention may determine the position of the sensor does not depend upon the intrinsic positioning accuracy of any device used to position the sensor. Thus, the need for a measurement arm or robot which can, through the use of expensive and accurate angular encoders, manipulate the sensor to a high degree of position accuracy is obviated. Thus, the present invention provides the opportunity for significant savings in terms of system hardware.

Optionally, the base measurement system is further arranged to determine the orientation of the sensor means with respect to the base measurement system. This allows the sensor to be manipulated accurately in up to six degrees of freedom in order that a part may be accurately inspected or machined. The processor means may be arranged to derive the orientation of features measured by the sensor means relative to the base measurement system.

The sensor means may be a non-contact distance measuring device, for example a laser stripe scanner that allows dense measurement data to be readily obtained. Alternatively, the sensor means may be an ultrasonic distance measuring device.

Optionally, the base measurement system comprises at least one imaging device. Conveniently, the at least one imaging device may be a metrology camera which may be arranged to determine the position of the sensor using features or targets associated with the sensor. Advantageously, metrology cameras function accurately over distances much greater than those over which a laser striper may be accurately used. Thus, the combination of metrology cameras, for determining the position of the sensor, and a laser striper, for inspecting a surface, allows dense measurement data for that surface to be established accurately in the frame of reference of the base measurement system, whilst the measured surface may be located at a great distance from, and/or hidden from the base measurement system. Thus, the sensor may be moved freely between locations in the working volume which would necessitate the relocation and recalibration of a base measurement system such as the base of a Faro arm, in the Modelmaker and Faro arm combination. Thus, the present invention provides the opportunity for significant savings in terms of time of operation, as processes such as setting up and recalibrating the base measurement system may be avoided.

Furthermore, the accuracy with which the position and orientation of the sensor may be determined is limited only by the accuracy of the metrology imaging system. Thus, for example, the accuracy with which the position and orientation of a tool associated with the sensor may be positioned, is limited only by the lesser of the accuracy of the metrology imaging system and the accuracy of the resolution to which the sensor may be manipulated; that is to say, the smallest differential point that the sensor may be moved to.

Optionally, the sensor means comprises at least one position indicating means, for example a light source and/or a retro-reflector. Advantageously, the retro-reflector may be coded.

The base measurement system may conveniently comprise at least one laser tracker.

Optionally, the system further comprises memory means associated with the processor means, the memory means storing CAD data relating to the sensor means and/or data relating to the location of the at least one position indicating means on the sensor means. Moreover, the CAD data may comprise code data relating to one or more of the position indicating means.

The system may further comprise handling means arranged to manipulate the sensor means, for example a robot or a co-ordinate measuring machine. Optionally, the handling means is arranged to manipulate the sensor means in response to signals generated by the processor means. Advantageously, the handling means may be further arranged to support a tool, for example a drill or welding device. Conveniently, the handling means may be mounted on a mobile base. Optionally, the handling means is arranged to move in response to signals generated by the processor means.

Optionally, the selected point lies on the surface of an item to be inspected or manufactured, such as an aircraft or a ship or a component or sub-assembly thereof.

According to a second aspect of the present invention, there is provided a method of measuring position information in computer aided manufacture or computer aided inspection, the method comprising the steps of: positioning a first measurement device in relation to a point to be measured; generating with the first measurement device distance information relating to the point; generating with a second measurement device, that is positionable independently of the first measurement device, position information relating to the first measurement device; and determining with the distance information and the position information further position information, the further position information relating to the position of the measured point relative to the position of the second measurement device.

Optionally, the step of generating position information relating to the first measurement device further comprises generating orientation information relating to the orientation of the first measurement device with respect to the second measurement device. The step of determining position information may further comprise determining further orientation information, the further orientation information relating to the orientation of the measured point relative to the second measurement device.

The step of generating position information relating to the first measurement device may further comprise the steps of: imaging at least a portion of the first measurement device or a structure associated with the first measurement device with the second measurement device; and calculating at least one vector passing between the second measurement device and a known point on the imaged portion of the first measurement device or structure. Optionally, the method further comprises the step of comparing the calculated vector with a further vector to determine the three dimensional location of the known point.

Conveniently, there may be a further step of attributing the determined three dimensional location to a corresponding point in a CAD model relating to the first measurement device or the associated structure. Furthermore, the method may include the steps of identifying a code associated with the known point on the imaged portion of the first measurement device or structure and comparing the identified code with a plurality of codes associated with the CAD model. Optionally, the method further comprises the steps of repeating the step of determining the three dimensional location of a known point for a plurality of known points and implementing a best fit algorithm to derive corresponding points in the CAD model relating to the first measurement device.

Optionally, the step of positioning the first measurement device further comprises the steps of receiving an operator input command and transmitting a control signal to a handling device in response to the input command, the handling device being arranged to position the first measurement device in response to the control signal. Advantageously, the method may further comprise the steps of generating with the second measurement device further position information relating to the first measurement device, comparing the further position information with the input command and transmitting a modified control signal to the handling device.

The point to be measured may be located on a part being manufactured or inspected. The part may be an aircraft structure, for example a wing or fuselage assembly.

Optionally, the first measurement device is a non-contact distance measuring device, for example a laser stripe scanner. The second measurement device may comprise at least one metrology camera.

The present invention also extends to a component or structure for an aircraft produced by the system or method of the invention. Furthermore, the present invention also extends to a computer program and a computer program product which are arranged to implement the system and method of the present invention as well as to measurements and CAD models and CAD data files produced using the system or method of the invention.

Specific embodiments of the present invention will now be described by way of example only, with reference to the accompanying drawings, in which:

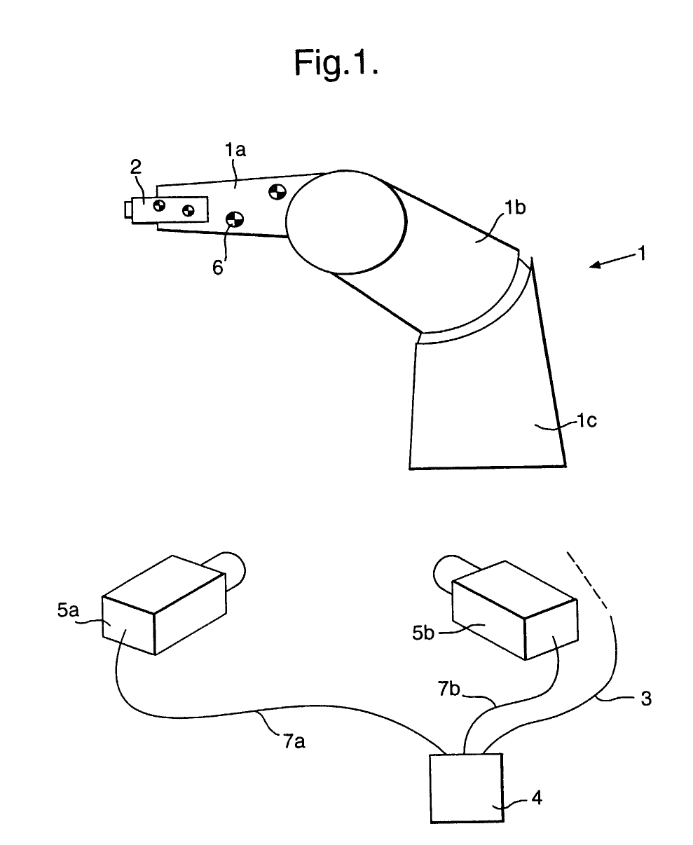

FIG. 1 is a schematic perspective illustration of the system of the first embodiment of the present invention; and

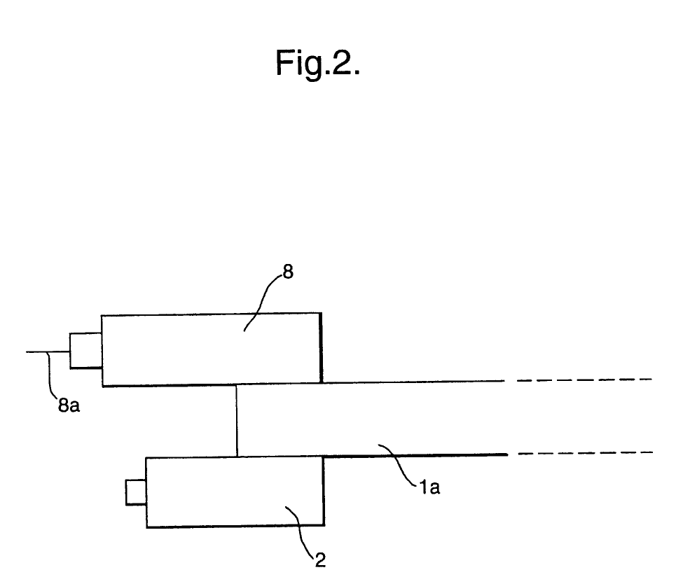

FIG. 2 is a fragmentary plan view of the wrist of the robot of the second embodiment of the present invention.

Referring to FIG. 1, the measurement system of the first embodiment is illustrated. The measurement system of the present embodiment consists of a remote sensor and a base measurement system. The remote sensor is a laser striper 2, which is rigidly mounted to the wrist 1a of a conventional industrial robot 1, in a conventional manner. Any suitable commercially available laser striper may be used, such as Modelmaker, for example.

The output of the laser striper 2 is connected via a suitable connector 3, such as a co-axial cable, to a processor 4, which may be a suitably programmed general purpose computer; the function of which is explained below.

The position and orientation of the laser striper 2 may be controlled in order to, carry out an inspection task by transmitting instructions from the processor 4 to the robot 1. The required number of degrees of freedom of movement possessed by the robot 1 is dictated by the requirements of the inspection task being undertaken. However, the present embodiment may be implemented using a robot with an end effector with up to six degrees of freedom, provided by articulations 5 between the wrist 1a and the arm 1b and between the arm 1b and the body 1c of the robot 1.

The base measurement system consists of two conventional photogrammetry cameras 5a and 5b in fixed locations, each of which has a field of view encompassing the volume in which the remote sensor is arranged to move. Associated with each camera 5a and 5b is an illumination source (not shown) which is located in close proximity with, and at the same orientation as the cameras 5a and 5b.

Associated with the remote sensor are a number of retro-reflective targets 6 used to determine the position and orientation of the remote sensor. The targets 6 are coded, using a conventional coding system, so that each target may be uniquely identified. Suitable coded targets are available from Leica Geosystems Ltd., Davy Avenue, Knowlhill, Milton Keynes, MK5 8LB, UK. The targets 6 are attached in a fixed relationship with the laser striper 2 in order to minimise any divergence between the measured position and orientation and the actual position and orientation of the laser striper 2. Thus, the targets 6 may be located on the laser striper 2, or, because the laser striper 2 is rigidly attached to the wrist 1a of robot 1, the targets 6 may also be located on the robot wrist 1a, as is shown in FIG. 1. Indeed, the targets 6 may be located on any other object rigidly associated with the laser striper 2.

The output of each of the cameras 5a and 5b is connected via a suitable connectors 7a and 7b, such as a co-axial cables, to the processor 4. As is explained further below, in the present embodiment, the output of the cameras 5a and 5b is analysed by the processor 4 during operation to provide instantaneous six degree of freedom position and orientation information relating to the laser striper 2.

Prior to the operation of the system, the frame of reference of the measurement volume, or work cell, of the base measurement system is determined in a conventional manner in the art. By doing so, position measurements of the remote sensor taken by cameras 5a and 5b may be related to the co-ordinate frame of reference of the base measurement system or indeed any further co-ordinate frame of reference of the measurement volume, or work cell.

This process is typically performed off-line, and there are several known methods of achieving this. One such method relies on taking measurements of control targets which are positioned at pre-specified locations in a known co-ordinate frame from numerous imaging positions. The measurements are then mathematically optimised so as to derive a transformation describing a relationship between each of the cameras 5a and 5b. Once the base measurement system co-ordinate frame has been derived, it is used to transform subsequent measurements of the targets 6 located on the remote sensor, in order that the position and orientation of the remote sensor may be established when the remote sensor is positioned at unknown positions and orientations relative to the imaging cameras 5a and 5b.

During operation, each camera 5a and 5b receives light which is emitted from its respective illumination source (not shown), and reflected by those targets 6 which have a direct line of sight with that camera 5a, 5b and its associated illumination source. As is well known in the art, retro-reflective targets reflect light incident on the reflector in the direction of travel of the incident light. Therefore, the positions of such targets may be established using two or more camera/illumination source pairs, using a conventional photogrammetry method, as is explained below.

The cameras 5a and 5b each output analogue or digital video signals via connections 7a and 7b, to the processor 4. The two signals correspond to the instantaneous two dimensional image of the targets 6 in the field of view of the cameras 5a and 5b, respectively.

Each video signal is periodically sampled and digitised by a frame grabber (not shown) associated with the processor 4 and is stored as a bit map in a memory (not shown) associated with the processor 4. Each stored bit map is associated with its corresponding bit map to form a bit map pair; that is to say, each image of the targets 6 as viewed by camera 5a is associated with the corresponding image viewed at the same instant in time by camera 5b.

Each bit map stored in the memory is a two dimensional array of pixel light intensity values, with high intensity values, or target images, corresponding to the location of targets 6 viewed from the perspective of the camera 5a or 5b from which the image originated.

The processor 4 analyses bit map pairs in sequence, in real time, in order to that the position and orientation of the remote sensor relative to the base measurement system may be continually determined in real time.

The processor 4 performs conventional calculations known in the art to calculate a vector for each target image in three dimensional space, using the focal length characteristics of the respective cameras 5a and 5b. In this way, for each target 6 that was visible to both cameras 5a and 5b, its image in one bit map of a pair has a corresponding image in the other bit map of the bit map pair, for which the respective calculated vectors intersect. The intersection points of the vectors, in three dimensions, each correspond to the position of a target 6 as viewed from the perspective of cameras 5a and 5b; i.e. in terms of the base measurement system co-ordinate frame of reference.

Once the positions of the targets 6 in a given bit map pair have been derived with respect to the co-ordinate frame of reference of the base measurement system, their positions are used to define the position and orientation of the remote sensor in the co-ordinate frame of reference of the base measurement system. This can be achieved using one of a variety of known techniques.

In the present embodiment, the three dimensional geometry of the combination of the laser striper 2 and the robot wrist 1a is accurately known. This is stored as computer aided design (CAD) data, or a CAD model in a memory (not shown) associated with the processor 4. In practice, the CAD model may be stored on the hard disc drive (or other permanent storage medium) of a personal computer, fulfilling the function of processor 4. The personal computer is programmed with suitable commercially available CAD software such as CATIA™ (available from IBM Engineering Solutions, IBM UK Ltd, PO Box 41, North Harbour, Portsmouth, Hampshire P06 3AU, UK), which is capable of reading and manipulating the stored CAD data. The personal computer is also programmed with software which may additionally be required to allow the target positions viewed by the cameras 5a, 5b, to be imported into the CAD software.

In the present embodiment, the CAD model also defines the positions at which each of the targets 6 is located on the laser striper 2 and the robot wrist 1a, together with the associated code for each target. By defining the three dimensional positions of a minimum number of three known points on the CAD model of the combination of the laser striper 2 and the robot wrist 1a, the position and orientation of the laser striper 2 is uniquely defined. Thus, the three dimensional positions of three or more targets 6, as imaged by cameras 5a and 5b and calculated by processor 4, are used to determine the position and orientation of the remote sensor, in terms of the co-ordinate frame or reference of the base measurement system.

The targets 6 which have been identified by processor 4 from the analysed bit map pairs and whose three dimensional position has been calculated are matched to the target locations on the CAD model. This is achieved by identifying from the codes on each target imaged by the cameras 5a and 5b the identity of those targets, in a conventional manner, and matching those targets with their respective positions on the CAD model, using the target code data stored in the CAD data. When this has been accomplished, the target positions in the CAD model which have been matched with an identified target are set to the three dimensional position measured for the corresponding target. When this has been done for three target positions on the CAD model, the position and orientation of the laser striper 2 is uniquely defined.

The skilled reader will appreciate that the present invention may alternatively be implemented using non-coded targets and then using a conventional best fit algorithm implemented by the processor 4 to match the three dimensional positions of the measured targets with the known locations stored in the CAD data. As a further alternative, such a best fit algorithm may be used to determine the position and orientation of the remote sensor using targets which are neither coded, nor located in known positions with respect to the remote sensor. However, in such an embodiment, a minimum of six non-linearly spaced, non-planar targets must be simultaneously visible to both of cameras 5a and 5b in order for a non-degenerate solution to be obtained.

It will also be understood that in the implementation of the present invention, the function of the base measurement system could be provided using a six degree of freedom probe or laser trackers. In the case of laser trackers, each laser tracker would be arranged to track the position of a given retro-reflector associated with the sensor, to give six degree of freedom position information relating to the sensor. Alternatively, if fewer position degrees of freedom were required, a correspondingly reduced number of laser tracker/retro-reflector pairs could be employed.

It will be understood that if the robot wrist 1a is free to move in such a manner that some targets 6 move out of the direct line of sight of one or other of the cameras 5a and 5b, then either further targets 6, or further cameras 5 located in different positions with respect to the remote sensor may be used to ensure that sufficient targets 6 are visible to sufficient cameras 5 at all times during operation.

In operation, the processor 4 repeatedly, instantaneously calculates the precise position and orientation of the remote sensor in relation to the base measurement system, as described above. Therefore, the signal received from the laser striper 2 and input into the processor 4 may be related to the frame of reference of the base measurement system, or of a further frame of reference in the working volume, using a conventional transformation.

Thus, the output of the laser striper 2, which defines the distance and direction, or X,Y positions of a multitude of discrete points on a surface, with respect to the laser striper 2, is transformed into a series of point measurements defined in six degrees of freedom in terms of the co-ordinate system of the base measurement system or further frame of reference in the working volume.

The position and orientation of the remote sensor may then be controlled by an operator inputting control entries in to processor 4, using for example a keyboard or a joystick (not shown). In this manner, the operator may use the system of the present embodiment to inspect components or structures with which neither the operator, nor the base measurement system has a direct line of sight. Moreover, the position and orientation of such components may be accurately measured using the system of the present embodiment. These measurements may be stored in the memory associated with the processor in the form of a CAD file, defining the surfaces of the part being inspected.

The control entries may either specify the absolute position and orientation of the robot wrist 1a or the remote sensor, or they may instead specify incremental position and orientation changes relative to its current position and orientation. In turn the processor 4 sends control signals to the robot 1 to manoeuvre its end effector to the desired location and orientation in relation to a part or assembly being inspected. The control signals may be subsequently adjusted by the processor 4, as is conventional in control theory, in dependence upon updated position and orientation information detected by the base measurement system.

In a second embodiment of the invention, the robot 1, supports a manufacturing tool in addition to the laser striper 2.

The system of the second embodiment fulfils the same functions and employs the same apparatus as described with respect to the first embodiment. Therefore, similar functionality and apparatus will not be described further in detail. However, in addition to the functionality of the first embodiment, the system of the second embodiment allows computer aided manufacturing processes to be carried out.

Referring to FIG. 2 the wrist 1a of the robot 1 is illustrated. As can be seen form the figure, the laser striper 2 is mounted to the wrist 1a of the robot 1 as previously described. In this embodiment, a drill 8 holding a drill bit 8a is also mounted to the wrist 1a. It will be noted that the orientation of the laser striper 2 and the drill 8 is the same with respect to the robot wrist 1a. This facilitates the positioning of the drill 8 with respect to a part to be worked, within the co-ordinate axes of the laser striper 2. As the drill bit 8a and the laser striper 2 are mounted on the robot wrist 1a in the same orientation, the geometrical relationship between the drill bit 8a and the laser striper 2 is an offset which may be defined in terms of the X, Y, and Z axes.

Therefore, using the system of the present embodiment, an operator of a manufacturing process, or an computer aided manufacturing (CAM) program may readily locate precise positions, such as the point on a part or assembly at which a hole is to be drilled, using the output of the laser striper 2. As described with reference to the first embodiment the output of the laser striper 2 is transformed to the co-ordinate measurement frame of the base measurement system.

Once such a location has been identified relative to the position of the laser striper 2, the processor 4 may readily calculate the relative positions of the identified location and the tip of the drill bit 8a. Thus, the robot wrist 1a may be simply manoeuvred in order to locate the drill bit 8a correctly with respect to the located drill point on the part or assembly in question under the control of the processor 4, as previously described.

It will be clear from the foregoing that the above described embodiments are merely examples of the how the invention may be put into effect. Many other alternatives will be apparent to the skilled reader which are in the scope of the present invention.

For example, although in the above described embodiments, the base measurement system was described as being a conventional photogrammetry system, it will be understood that other systems which may be used to yield a six degree of freedom position of the remote sensor may instead be used. For example, three laser trackers, each tracking a separate retro-reflector mounted on the remote sensor, or equivalent system could also be used. Alternatively, the base measurement system could consist of two or more cameras which output images of the remote sensor to a computer programmed with image recognition software. In such an embodiment, the software would be trained to recognise particular recognisable features of the remote sensor in order to determine the position and orientation of the remote sensor in respect of the cameras.

It will also be understood that the invention may be applied to a system in which the remote sensor is free to move in fewer than six degrees of freedom. For example, if an embodiment of the invention is used only to position a drill bit relative to a work piece, then it will be understood that due to the symmetry of the drill bit, the rotational degree of freedom about the longitudinal axis of the drill bit may not be required to implement the embodiment. As a further example, an embodiment of the invention may be implemented in which two or three translational degrees of freedom along the X, Y and Z axes, are measured. The remaining degrees of freedom may be either unused or determined by other means. It will also be understood that a similar embodiment in which only two or three rotational degrees of freedom are measured may also be implemented.

It will also be appreciated that although no particular details of the robot 1 were given, any robot, such as a Kuka™ industrial robot, with a sufficient movement resolution and sufficient degrees of freedom of movement for a given task may be used to implement the invention. However, the robot body may be mobile; i.e. the robot body need not be located in a fixed position. For example, it may be mounted on rails and thus be able to access a large portion or the whole of even a large assembly, such as an aircraft fuselage. In such an embodiment, as the robot could derive the position and orientation of its end effector through the measurements of the base measurement system, the need for the robot to have an accurate position measurement system defining the location of its body may be obviated.

Furthermore, the processor of the present invention may be programmed not only to control the articulation or movement of the robot arm, using position information derived from the base measurement system, but using this information it may also control the location of the body of a mobile robot. Indeed, the system of the present invention may be used to implement automated inspection and manufacturing tasks, carried out by a robot as described, under the control of a suitably programmed processor.

It will be appreciated that if the robot used to support the remote sensor has position encoders which are of sufficient accuracy, and the robot linkages are sufficiently rigid so as to not flex beyond the required system position tolerances, then the targets attached to the remote sensor could be partially or wholly attached to part of the robot separated from the remote sensor by one or more articulation points on the robot arm.

Although the above embodiments use a laser striper as the remote sensor, it will be appreciated that other sensors or transducers such as ultrasonic distance measuring devices may also be used to advantage in the present invention.

1. A measurement system for use in computer aided manufacture or computer aided inspection comprising a base measurement system (4, 5a, 5b, 7a, 7b) and a sensor means (2), the sensor means being movable independently of the base measurement system and being arranged to determine the distance between the sensor means and a selected point, the base measurement system being arranged to determine the position of the sensor means relative to the base measurement system, the system comprising processor means (4) being arranged to receive information generated by the base measurement system and the sensor means and the processor means being further arranged to derive position information relating to the selected point relative to the base measurement system.

2. A system according to claim 1, wherein the base measurement system is further arranged to determine the orientation of the sensor means with respect to the base measurement system.

3. A system according to claim 1 or claim 2, wherein, the processor means is arranged to derive the orientation of features measured by the sensor means relative to the base measurement system.

4. A system according to any preceding claim, wherein the sensor means is a laser stripe scanner.

5. A system according to any preceding claim, wherein the base measurement system comprises at least one imaging device and/or at least one laser tracker.

6. A system according to any preceding claim, wherein the sensor means comprises at least one position indicating means having a light source and a retro-reflector.

7. A system according to any preceding claim, further comprising memory means associated with the processor means, the memory means storing CAD data relating to the sensor means.

8. A system according to any preceding claim, further comprising handling means arranged to manipulate the sensor means and a tool mounted on the handling means.

9. A method of measuring position information in computer aided manufacture or computer aided inspection, the method comprising the steps of:
positioning a first measurement device in relation to a point to be measured;
generating with the first measurement device distance information relating to the point;
generating with a second measurement device, that is positionable independently of the first measurement device, position information relating to the first measurement device; and
determining with the distance information and the position information further position information, the further position information relating to the position of the measured point relative to the position of the second measurement device.

10. A method according to claim 9, wherein the step of generating position information relating to the first measurement device further comprises the steps of;
imaging at least a portion of the first measurement device or a structure associated with the first measurement device with the second measurement device; and
calculating at least one vector passing between the second measurement device and a known point on the imaged portion of the first measurement device or structure.

11. A component or structure whose manufacture includes the method of claims 9 or 10.

12. An aircraft whose manufacture includes the method of claims 9 or 10.

13. A computer program comprising program code means for performing the method steps of claims 9 or 10 when the program is run on a computer and/or other processing means associated with suitable measurement devices.

14. A computer program product comprising program code means stored on a computer readable medium for performing the method steps of claims 9 or 10 when the program is run on a computer and/or other processing means associated with suitable measurement devices.
